(19) United States
(12) Patent Application Publication
(10) Pub. No.: US 2003/0107281 A1
(43) Pub. Date: Jun. 12, 2003

(54) Hydrodynamic pressure bearing system and spindle motor using the same

(75) Inventor: Rikuro Obara, Miyota-machi (JP)

Correspondence Address: OLIFF & BERRIDGE, PLC, P.O. BOX 19928, ALEXANDRIA, VA, 22320, US

(73) Assignee: Minebea Co., Ltd., Miyota-machi (JP)

(21) Appl. No.: 10/314,264

(22) Filed: Dec. 9, 2002

(30) Foreign Application Priority Data
Dec. 11, 2001 (JP) 2001-377053

(51) Int. Cl. H02K 5/16

(52) U.S. Cl. 310/90

(57) ABSTRACT

A shaft secured to a hub is inserted and rotatably supported in a sleeve secured to a base. A dynamic pressure groove is formed in the inner peripheral surface of the sleeve, and lubricant is sealed between the shaft and the sleeve. The rotation of the shaft causes dynamic pressure to generate in the lubricant due to the dynamic pressure groove, supporting the shaft floatingly. The ceramic sleeve allows heat generated in a coil to be hardly transferred to the shaft, thereby reducing the variations in the clearance between the shaft and the sleeve due to temperature changes to a minimum in cooperation with the ceramics sleeve with a low thermal expansion coefficient. Consequently, the rotation accuracy can be improved and the leakage of lubricant due to the variations in the clearance can be prevented.

### BACKGROUND OF THE INVENTION

1. Field of the Invention

The present invention relates to a hydrodynamic pressure bearing system for a spindle motor or the like for driving a magnetic disc of a hard disk drive of a computer, and a spindle motor using the same.

2. Description of the Related Art

Recently, in hard disk drives of computers, bearings of spindle motors for driving magnetic discs are required to have high rotation accuracy, low friction, low noise, and long life as the magnetic discs have higher density and higher rotation speed. In order to satisfy such demands, spindle motors using hydrodynamic pressure bearing systems have been developed.

The hydrodynamic pressure bearing system seals fluid between a shaft and a sleeve for supporting the shaft, and forms dynamic pressure grooves at the caliber of the sleeve, thereby generating dynamic pressure in the fluid by the rotation of the shaft and supporting the shaft in a floating manner by the dynamic pressure. The hydrodynamic pressure bearing system has a fluid layer formed between the shaft and the sleeve, and thus support the shaft without mechanical friction by keeping them from contact with each other. Therefore, high rotation accuracy, low friction, low noise, and long life can be achieved.

However, the conventional hydrodynamic pressure bearing systems have the following problems: In general, the shafts and the sleeves of hydrodynamic pressure bearing systems of the spindle motor for hard disk drives are made of stainless steel, having a high thermal coefficient of expansion, thus causing change in dimension with temperature to vary the clearance therebetween. The variations in the clearance between the shaft and the sleeve exerts a direct influence on the dynamic pressure of the fluid, causing a decrease in rotation accuracy and also the leakage of the fluid sealed in the clearance. In this case, since the shaft or sleeve on the coil side of the spindle motor easily increases in temperature, causing a temperature gradient between the shaft and the sleeve and increasing dimensional differentials due to thermal expansion, thus posing a serious problem.

### SUMMARY OF THE INVENTION

The present invention has been made in consideration of the above problems, and accordingly, it is an object of the present invention to provide a hydrodynamic pressure bearing system capable of reducing the variations in the clearance between a rotating member and a supporting member due to thermal expansion to a minimum, and a spindle motor assembly using the same.

In order to solve the above problems, in the invention according to a first aspect of the present invention, a hydrodynamic pressure bearing system includes a supporting member and a rotating member, wherein fluid is sealed between the supporting member and the rotating member, the supporting member and the rotating member are floatingly supported by dynamic pressure generated in the fluid by the rotation of the rotating member, and wherein at least one of the supporting member and the rotating member is made of ceramics.

With such a configuration, the thermal expansion coefficient of the supporting member or the rotating member made of ceramics becomes low, and thermal transfer to other members can be reduced.

In the hydrodynamic pressure bearing system according to the first aspect of the invention, the heated side of the supporting member and the rotating member is made of ceramics.

With such a configuration, the thermal expansion coefficient of the heated side of the supporting member and the rotating member becomes low, and also thermal transfer to other members can be reduced.

In the invention according to a second aspect of the present invention, in a spindle motor assembly using a hydrodynamic pressure bearing system comprising a supporting member and a rotating member, fluid is sealed between the supporting member and the rotating member, and the supporting member and the rotating member are floatingly supported by dynamic pressure generated in the fluid by the rotation of the rotating member, wherein at least one of the supporting member and the rotating member is made of ceramics.

With such a configuration, the thermal expansion coefficient of the supporting member or the rotating member made of ceramics becomes low, and also thermal transfer to other members is reduced.

In the spindle motor according to the second aspect of the invention, out of the supporting member and the rotating member, the side to be heated with a coil of the spindle motor assembly is made of ceramics.

With such a configuration, out of the supporting member and the rotating member, the thermal expansion coefficient of the one heated by the coil becomes low, and the heat of the coil is hardly transferred to other members.

### BRIEF DESCRIPTION OF THE DRAWINGS

FIG. 1 is a longitudinal sectional view of a spindle motor assembly according to a first embodiment of the present invention.

FIG. 2 is a longitudinal sectional view of a spindle motor assembly according to a second embodiment of the present invention.

### DESCRIPTION OF THE PREFERRED EMBODIMENTS

Embodiments of the present invention will be specifically described hereinbelow with reference to the drawings.

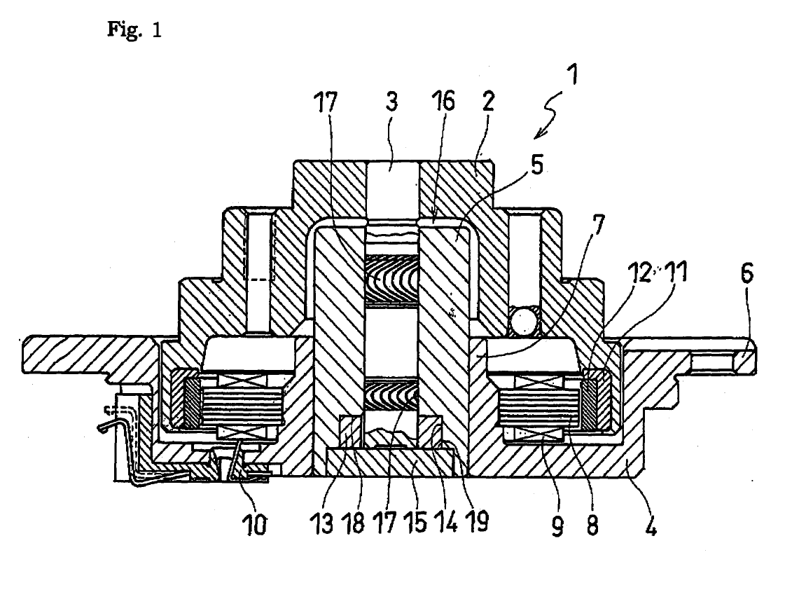

Referring to FIG. 1, a first embodiment of the invention will be discussed. As shown in FIG. 1, a spindle motor assembly 1 according to this embodiment uses a shaft rotating system for driving a magnetic disc in a hard disk drive of a computer or the like, wherein a shaft 3 (rotating member) secured to a hub 2 side is rotatably supported by a cylindrical sleeve 5 (supporting member) secured to a base 4 side.

The base 4 has a substantially cylindrical shape with a bottom and has a flange 6 at the rim thereof, wherein a sleeve 5 is press fitted and fixed in a cylindrical portion 7 formed at the center of the bottom. The cylindrical portion 7 has a stator stack 8 attached at the outside periphery thereof, the stator stack 8 being arranged in a ring shape and extending radially, and a coil 9 is wound around the stator stack 8. The base 4 has a connector 10 connected to the coil 9.

The hub 2 has a substantially cylindrical shape with a bottom and a stepped side,-wherein the shaft 3 is press fitted in an opening at the center of the bottom, wherein a ring-shaped yoke 11 is attached to the inner periphery of the outermost side wall, and wherein a ring-shaped magnet 12 is attached to the inside of the yoke 11. The hub 2 is fitted into the base 4 with a predetermined clearance between the outermost side thereof and the base 4. The shaft 3 is rotatably inserted into the sleeve 5 on the base 4 side, and is rotatably supported with respect to the base 4 with the inner periphery of the magnet 12 facing the outer periphery of the stator stack 8.

At the end of the shaft 3 inserted into the sleeve 5 is attached a thrust plate 13 and is rotatably fitted in a large-diameter portion 14 in the sleeve 5. The thrust plate 13 and the shaft 3 are supported by the end surface of the large-diameter portion 14 and a counter plate 15, which is press fitted, secured, and sealed into the end of the sleeve 5, in an axial direction with a small clearance.

Subsequently, a hydrodynamic pressure bearing system 16, which rotatably supports the shaft 3 and the sleeve 5, will be described. A dynamic pressure groove 17 is formed in the inner peripheral surface of the sleeve 5; a dynamic pressure groove 18 is formed in a surface of the large-diameter portion 14 of the sleeve 5, which faces the thrust plate 13; and a dynamic pressure groove 19 is formed in a surface of the counter plate 15, which faces the thrust plate 13. Lubricating oil (fluid) is sealed in the clearances between the shaft 3 and the thrust plate 13, and the sleeve 5 and the counter plate 15. When the shaft 3 and the thrust plate 13 are rotated in a predetermined direction, dynamic pressure is generated in the lubricating oil due to the dynamic pressure grooves 17, 18, and 19, and accordingly, the shaft 3 and the thrust plate 13 are floatingly supported with respect to the sleeve 5 and the counter plate 15 due to the dynamic pressure.

In the hydrodynamic pressure bearing system 16, the sleeve 5 is made of ceramics, and the shaft 3, the thrust plate 13, and the counter plate 15 are made of stainless steel. Alternatively, any or all of the shaft 3, the thrust plate 13, and the counter plate 15 may be made of ceramics. Alternatively, in place of making the whole members of ceramics, only the surface may be made of ceramics. It is preferable that the ceramics material to be used here have higher thermal insulation and lower thermal expansion coefficient than stainless steel, and mechanical characteristics of sufficient strength, wear resistance, corrosion resistance, workability and the like to be used as a sleeve 5, a shaft 3, a thrust plate 13, and a counter plate 15. For example, it is possible to use silicon nitride, silicon carbide, zirconium, alumina or the like. Also, Ti₂O₃, FeO₄, FeO, MnO₂, MoO₂, VO, TiC, ZrO₂ or the like may be used as electrically conductive ceramics.

The operation of this embodiment as configured above will be described hereinbelow.

A magnetic disc (not shown) is mounted on the stepped outer periphery of the hub 2 and is rotated with the hub 2 by applying electric current to the coil 9, thereby writing and reading data with a magnetic head (not shown). At that time, when the shaft 3 is rotated in a predetermined direction, dynamic pressure is generated in the lubricating oil sealed into the clearances between the shaft 3 and the thrust plate 13, and the sleeve 5 and the counter plate 15 due to the dynamic pressure grooves 17, 18, and 19, and the dynamic pressure brings them into non-contact with each other, thereby forming a bearing system without mechanical friction. Accordingly, high rotation accuracy, low friction, low noise, long life, and high-speed rotation can be achieved.

Since the sleeve 5 is made of ceramics, heat generated in the coil 9 is hardly transferred to the shaft 3, the thrust plate 13, and the counter plate 15, the heat expansion thereof can be reduced. Accordingly, the variations in the clearance at the rotating portion of the hydrodynamic pressure bearing system 16 due to temperature changes can be reduced to a minimum in cooperation with the sleeve 5 made of ceramics with a low thermal expansion coefficient. Consequently, the rotation accuracy can be improved, and also the leakage of the lubricant due to the variations in the clearance can be prevented.

In this case, since the dynamic pressure grooves 17 and 18 are formed not on the ceramics sleeve 5 side but on the shaft 3 side and the thrust plate 13 side made of stainless steel having high workability, they can easily be formed. Also, since only the sleeve 5 of the hydrodynamic pressure bearing system 16 is made of ceramics, and the shaft 3, the thrust plate 13, and the counter plate 15 are made of stainless steel as in the conventional art, an increase in manufacturing cost can be reduced to a minimum.

Furthermore, when any of the shaft 3, the thrust plate 13, and the counter plate 15 is made of ceramics, the thermal expansion coefficient thereof can be decreased; therefore, the variations in the clearance at the rotating portion of the hydrodynamic pressure bearing system 16 due to temperature changes can be further reduced. In this case, the workability of the dynamic pressure grooves 17, 18, and 19 can be improved by appropriately selecting a member with higher workability. Also, by making all the members of ceramics, the thermal expansion and thermal transfer can be reduced to a minimum. In addition, when the above-mentioned conductive ceramics is used as a ceramics material, antistatic effects can be obtained.

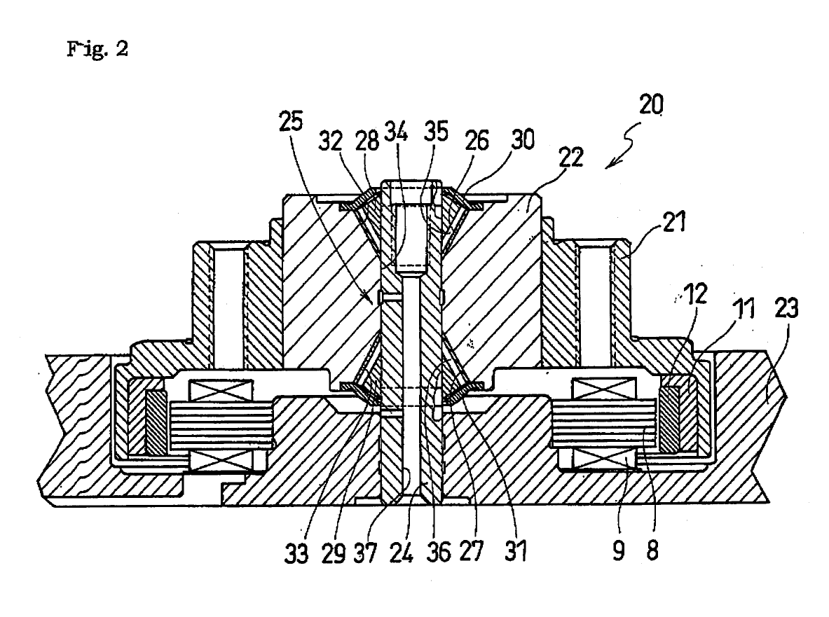

Subsequently, referring to FIG. 2, a second embodiment of the invention will be described. Elements similar to those of the first embodiment are given the same reference numerals and only different elements will be described in detail.

As shown in FIG. 2, a spindle motor assembly 20 according to the second embodiment uses a fixed shaft system, wherein a sleeve 22 (rotating member) secured to a hub 21 side is rotatably supported by a shaft 24 (supporting member) secured to a base 23 side.

The base 23 has a substantially cylindrical shape with a bottom, wherein a shaft 24 is press fitted and secured in an opening formed at the center of the bottom. The stator stack 8 arranged in a ring shape and extending radially is attached to a ring-shaped recessed portion formed around a shaft mounting portion, and the coil 9 is wound around the stator stack 8. The base 23 has a connector (not shown) to be connected to the coil 9, attached thereto.

The hub 21 has a substantially cylindrical shape with a bottom and a stepped side, wherein the cylindrical sleeve 22 is press fitted and secured in an opening formed at the center of the bottom, wherein the ring-shaped yoke 11 is attached to the inner periphery of the outermost side wall of the hub 21, and wherein the ring-shaped magnet 12 is attached to the inside of the yoke 11. The hub 21 is fitted into the base 23 with a predetermined clearance between the outermost side thereof and the base 23. The shaft 24 is rotatably inserted into the sleeve 22 on the base 23 side, and is rotatably supported with respect to the base 23 with the inner peripheral surface of the magnet 12 facing the outer periphery of the stator stack 8.

Subsequently, a hydrodynamic pressure bearing system 25, which rotatably supports the sleeve 22 and the shaft 24, will be described. The sleeve 22 has tapered surfaces 26 and 27 expanding outwards formed at both ends on the inner peripheral surface thereof. Cones 28 and 29 having conic surfaces facing the tapered surfaces 26 and 27 of the sleeve 22, respectively, are press fitted and secured into the outer periphery of the shaft 24. The sleeve 22 and the shaft 24 are mutually and rotatably supported in an axial direction by the tapered surfaces 26 and 27 and the conic surfaces of the cones 28 and 29. The sleeve 22 has shields 30 and 31 for holding lubricating oil between the sleeve 22 and the shaft 24, attached at both ends thereof and in the proximity of the outer peripheral surface of the shaft 24.

The sleeve 22 has dynamic pressure grooves 32, 33, and 34 formed in the tapered surfaces 26 and 27 thereof and the inner peripheral surface therebetween. Lubricating oil is sealed in a space between the sleeve 22 and the shaft 24, spaces enclosed by the tapered surfaces 26 and 27, the cones 28 and 29, and the shields 30 and 31, respectively, and in oil passages 35 and 36. When the sleeve 22 is rotated in a predetermined direction, dynamic pressure is generated in the lubricating oil due to the dynamic pressure grooves 32, 33, and 34, which floatingly supports the sleeve 22 with respect to the shaft 22 and the cones 28 and 29. The shaft 24 is provided with an air vent 37 for introducing air between the sleeve 22 and the shaft 24 and balancing the pressure applied to the lubricating oil.

In the hydrodynamic pressure bearing system 25, the shaft 24 is made of ceramics, and the cones 28 and 29 and the sleeve 22 are made of stainless steel. Alternatively, any or all of the cones 28 and 29 and the sleeve 22 may be made of ceramics. The ceramics material used in this embodiment is the same as that of the first embodiment.

The operation of this embodiment as configured above will be described hereinbelow.

In a manner similar to the first embodiment, a magnetic disc (not shown) is mounted on the stepped outer periphery of the hub 21 and is rotated with the hub 21 by the introduction of electric current to the coil 9, thereby writing and reading data with a magnetic head (not shown). At that time, when the sleeve 22 is rotated in a predetermined direction, dynamic pressure is generated in the lubricating oil sealed in the clearance between the sleeve 22 and the shaft 24, and the clearance between the cones 28 and 29 and the shields 30 and 31 due to the dynamic grooves 32, 33, and 34, which brings them into non-contact with each other, thereby forming a bearing system without mechanical friction. Accordingly, high rotation accuracy, low friction, low noise, long life, and high-speed rotation can be achieved.

Since the shaft 24 is made of ceramics, heat generated in the coil 9 is hardly transferred to the cones 28 and 29 and the sleeve 22; therefore, the heat expansion thereof can be reduced. Accordingly, the variations in the clearance at the rotating portion of the hydrodynamic pressure bearing system 25 due to temperature changes can be reduced to a minimum in cooperation with the shaft 24 made of ceramics with a low thermal expansion coefficient. Consequently, the rotation accuracy can be improved, and also the leakage of the lubricating oil due to the variations in the clearance can be prevented.

In this case, since only the shaft 24 of the hydrodynamic pressure bearing system 25 is made of ceramics, and the cones 28 and 29 and the sleeve 22 are made of stainless steel, as in the conventional art, an increase in manufacturing cost can be reduced to a minimum.

Furthermore, when either the cones 28 and 29 or the sleeve 22 is made of ceramics, the thermal expansion coefficient thereof is decreased; as a result, the variations in the clearance at the rotating portion of the hydrodynamic pressure bearing system 25 due to temperature changes can be further reduced. In this case, the workability of the dynamic pressure grooves 32, 33, and 34 can be improved by appropriately selecting a member with higher workability. Also, by making all the members of ceramics, the thermal expansion and thermal transfer can be reduced to a minimum. In addition, when the above-mentioned conductive ceramics is used as a ceramics material, antistatic effects can be obtained.

As specifically described above, in the hydrodynamic pressure bearing system according to the first aspect of the invention, since at least one of the supporting member and the rotating member is made of ceramics, the thermal expansion coefficient of the supporting member or the rotating member made of ceramics becomes low, and also thermal transfer to other members can be reduced. Accordingly, the variations of the clearance between the supporting member and the rotating member due to temperature changes can be reduced. Consequently, the rotation accuracy can be improved and also the leakage of the fluid due to the variations of clearance can be prevented.

In the hydrodynamic pressure bearing system according to the first aspect of the invention, since the heated side of the supporting member and the rotating member is made of ceramics, the thermal expansion coefficient of the heated side becomes low, and thermal transfer to other members is reduced. Accordingly, the variations of the clearance between the supporting member and the rotating member due to temperature changes can be reduced effectively.

In the spindle motor assembly according to the second aspect of the invention, since at least one of the supporting member and the rotating member of the hydrodynamic pressure bearing system is made of ceramics, the thermal expansion coefficient of the supporting member or the rotating member made of ceramics becomes low, and also thermal transfer to other members is reduced. Accordingly, the variations of the clearance between the supporting member and the rotating member due to temperature changes can be reduced. Consequently, the rotation accuracy can be improved and also the leakage of the fluid due to the variations of clearance can be prevented.

In the spindle motor assembly according to the second aspect of the invention, since out of the supporting member and the rotating member of the hydrodynamic pressure bearing system, the side to be heated with the coil is made of ceramics, the thermal expansion coefficient of the one heated by the coil becomes low, and the heat of the coil is hardly transferred to other members. Accordingly, the variations of the clearance between the supporting member and the rotating member due to temperature changes can be reduced effectively.

What is claimed is:

1. A hydrodynamic pressure bearing system comprising:
a supporting member; and
a rotating member;
wherein fluid is sealed between the supporting member and the rotating member, the supporting member and the rotating member are floatingly supported by dynamic pressure generated in the fluid by the rotation of the rotating member; and at least one of the supporting member and the rotating member is made of ceramics.

2. The hydrodynamic pressure bearing system according to claim 1, wherein the heated side of the supporting member and the rotating member is made of ceramics.

3. A spindle motor using a hydrodynamic pressure bearing system comprising:
a supporting member; and
a rotating member;
wherein fluid is sealed in the supporting member and the rotating member; and the supporting member and the rotating member are floatingly supported by dynamic pressure generated in the fluid by the rotation of the rotating member; wherein
at least one of the supporting member and the rotating member is made of ceramics.

4. The spindle motor according to claim 3, wherein out of the supporting member and the rotating member, the side to be heated with a coil of the spindle motor assembly is made of ceramics.
